(19) United States
(12) Patent Application Publication
(10) Pub. No.: US 2010/0315507 A1
(43) Pub. Date: Dec. 16, 2010

(54) SURVEILLANCE SYSTEM INCLUDING A LARGE NUMBER OF CAMERAS

(75) Inventors: Philippe Chrobocinski, Charenton Le Pont (FR); Guilhem Varangot, Paris (FR); Frédéric Perlant, Paris (FR)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: EADS Defence and Security Systems, Elancourt (FR)

(21) Appl. No.: 12/866,316

(22) PCT Filed: Jan. 30, 2009
(86) PCT No.: PCT/FR09/50139

§ 371 Date: Aug. 5, 2010

(30) Foreign Application Priority Data
Feb. 6, 2008 (FR) FR 0850762

(51) Int. Cl. H04N 7/18

(52) U.S. Cl. 348/143; 348/E07.085

(57) ABSTRACT

The surveillance system includes video detectors, and central aggregation device including a control device for controlling the video detectors, and a display device and image analysis device for displaying and analyzing images coming from one or more video detectors. The system further includes an intermediate aggregation device connected to a subset of the video detectors and to the central aggregation device, and including a merging device adapted to analyze the images from at least two video detectors of the subset of video detectors in order to trigger an alarm sent to the central aggregation device as a function of the result of the analysis.

### PRIORITY CLAIM

This application is a 371 filing from PCT/FR2009/050139 filed Jan. 30, 2009, which claims priority from French Application for Patent No. 0850762 filed Feb. 6, 2008, the disclosures of which are hereby incorporated by reference.

### TECHNICAL FIELD

The present invention relates to a surveillance system including a plurality of video detectors and central aggregation means including display means and image analysis means for displaying and analyzing images coming from one or more of the video detectors.

### BACKGROUND

In the field of surveillance systems using video detectors, or video cameras, two types of architecture are known as the function of the type of user and as a function of utilization constraints.

For security surveillance of areas, a large number of cameras, possibly being grouped together about a plurality of nodes, are connected to a control room or central security station. Operators can control remotely-controllable cameras, and can cause the images they receive to be displayed on a plurality of screens. As a general rule, there is one screen per camera, with options for switching between a plurality of cameras. That type of system has the drawback of requiring a large number of operators in order to make use of the information. Furthermore, the reliability of the system depends to a large extent on the human attention of the operators, and on their capacity for analysis. Sometimes the received images are stored for possible subsequent analysis, with said storage usually being performed without metadata being added for the purpose of facilitating searching.

The second type of surveillance system is used for the purpose of preventing intrusions onto a site. The images of the cameras are then processed locally, as close as possible to the camera, in order to generate alarms. The alarms are then centralized in a central security station. That type of system performs two functions: displaying the alarms, and giving access to the information from the sensors.

Those systems are limited in the number of cameras they can manage. In particular, in a system having several hundreds or thousands of cameras, and ignoring any other types of sensor, surveillance teams in the central control station rapidly become too large, and that leads to problems of coordination, or indeed to operators being submerged by the amount of information that needs to be monitored and processed.

Thus, it would be particularly advantageous to have a surveillance system capable of managing very many cameras while also limiting the number of tasks to be performed by the operators and limiting the complexity of those tasks.

### SUMMARY

Thus, in a first aspect, the invention provides a surveillance system comprising a plurality of video detectors, and central aggregation means comprising control means for controlling the video detectors, and display means and image analysis means for displaying and analyzing images coming from one or more video detectors, the system being characterized in that it further includes intermediate aggregation means connected to a subset of the video detectors and to the central aggregation means, and including merging means adapted to analyze the images from at least two video detectors of the subset of video detectors in order to trigger an alarm sent to the central aggregation means as a function of the result of said analysis.

Other characteristics and embodiments of this aspect are specified below:

the intermediate aggregation means further include control means for controlling the video detectors of the subset of video detectors and adapted to broadcast commands received from the control means of the central aggregation means towards the video detectors;

the intermediate aggregation means are adapted to send images to the central aggregation means only on the request of said central aggregation means, or in association with said alarm;

the system further includes local aggregation means associated with one of the video detectors and including image analysis means for analyzing images from said detector, and control means for controlling said detector;

the local aggregation means also include interface means interfacing with at least one non-video sensor and they are adapted to transmit images from said video detector to the intermediate aggregation means in response to an event being detected by at least one of said non-video sensors;

the image analysis means of the local aggregation means are adapted to send an alarm to the intermediate aggregation means;

the alarm is forwarded to the central aggregation means by the intermediate aggregation means;

local aggregation means are connected to at least two intermediate aggregation means; and

some intermediate aggregation means are put in reserve in order to enable the hierarchy of links between the local aggregation means, the intermediate aggregation means, and the central aggregation means to be configured dynamically.

### BRIEF DESCRIPTION OF THE DRAWINGS

The invention can be better understood on reading the following description of embodiments given purely by way of example and made with reference to the accompanying drawings, in which:

FIG. 1 is a diagrammatic view of a surveillance system in an embodiment of the invention;

FIG. 2 is a diagrammatic view of local aggregation means of the FIG. 1 surveillance system;

FIG. 3 is a diagrammatic view of intermediate aggregation means of the FIG. 1 surveillance system; and

FIG. 4 is a diagrammatic view of central aggregation means of the FIG. 1 surveillance system.

### DETAILED DESCRIPTION OF THE DRAWINGS

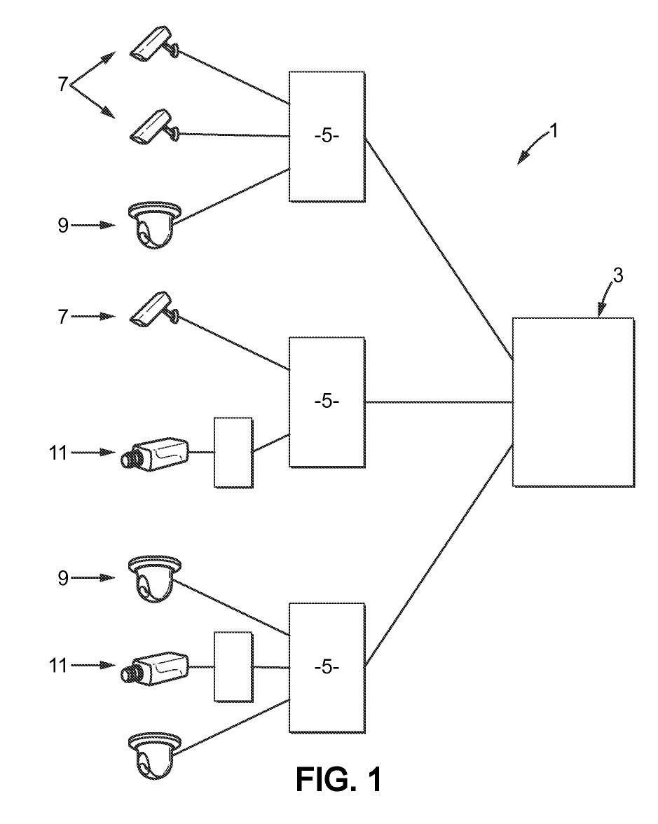

With reference to FIG. 1, a surveillance system 1 includes central aggregation means 3 connected to intermediate aggregation means 5. The intermediate aggregation means 5 are connected to stationary cameras 7, to motor-driven cameras 9 capable of monitoring a large area from a fixed point by means of motor drive in rotation, and intelligent cameras 11.

Other types of camera can also be connected to the surveillance system 1, such as, for example: moving cameras fastened to drones, vehicles, or people; cameras embedded in mobile telephones; etc.

The cameras may also operate at different wavelengths. For example, some cameras may operate in the infrared and others in visible light.

Preferably, the connections between the various elements of the surveillance system 1 are based on digital data transfer protocols. Depending on the configuration, they may make use of different physical media such as, for example: electrical power lines; optical fibers; and/or radio waves.

As shown in FIG. 2, an intelligent camera 11 comprises an actual camera 20 together with local aggregation means 22.

The local aggregation means 22 comprise image analysis means 24 for analyzing images generated by the camera 20 together with control means 26 for controlling the camera.

The control means 26 are connected to a database 28 containing parameters that are characteristic of the camera 20 and receiving orders for controlling the intermediate aggregation means 5.

In order to optimize the independence and the local analysis of images, the local aggregation means 22 also include interface means 30 providing an interface with non-video sensors 32, e.g. with seismic sensors. Thus, the analysis means 24 are capable of selecting video processing that is specific, as a function of events that are difficult or impossible to detect by algorithms for analyzing a scene.

The construction of units for cameras and other sensors and also for local aggregation means 22 are optimized for environmental constraints that may be difficult, such as low electricity consumption, a low form factor, high resistance to impacts, to vibration, to a high temperatures, and to electromagnetic interference.

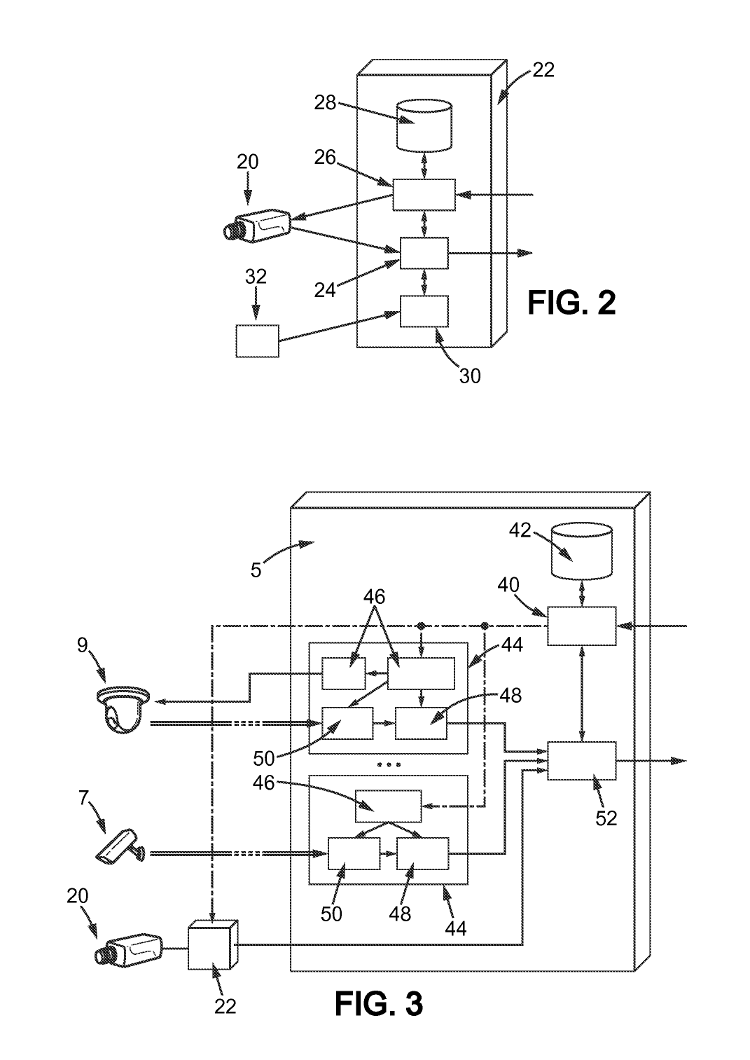

As shown in FIG. 3, the intermediate aggregation means 5 comprise control means 40 for controlling a set of cameras 7, 9, and 20, and relying on a database 42 containing the characteristics of these cameras.

The control means 40 send orders to the local aggregation means 22 for the camera 20 and to specific control means 44 of a given camera.

The specific control means 44 are similar to the local aggregation means 22 in that they likewise include camera control means 46 and image analysis means 48. They also include encoder means 50 for encoding the images received from the corresponding camera.

The intermediate aggregation means 5 also include merging means 52 capable of integrating image analyses coming from at least two cameras in order to trigger an alarm for sending to the central aggregation means 3.

A simple example of fusion consists in processing the images of two spaced-apart cameras having parallel fields of view in order to construct a stereoscopic image enabling particular events to be detected.

Another example consists in tracking the movement of an individual or of a moving object by means of a succession of cameras that detect movement.

Certain alarms, generated in particular by the local aggregation means 22, are sent back directly to the central aggregation means 3.

The intermediate aggregation means 5 receive orders from the central aggregation means 3 and send them alarms and images via the merging means 52.

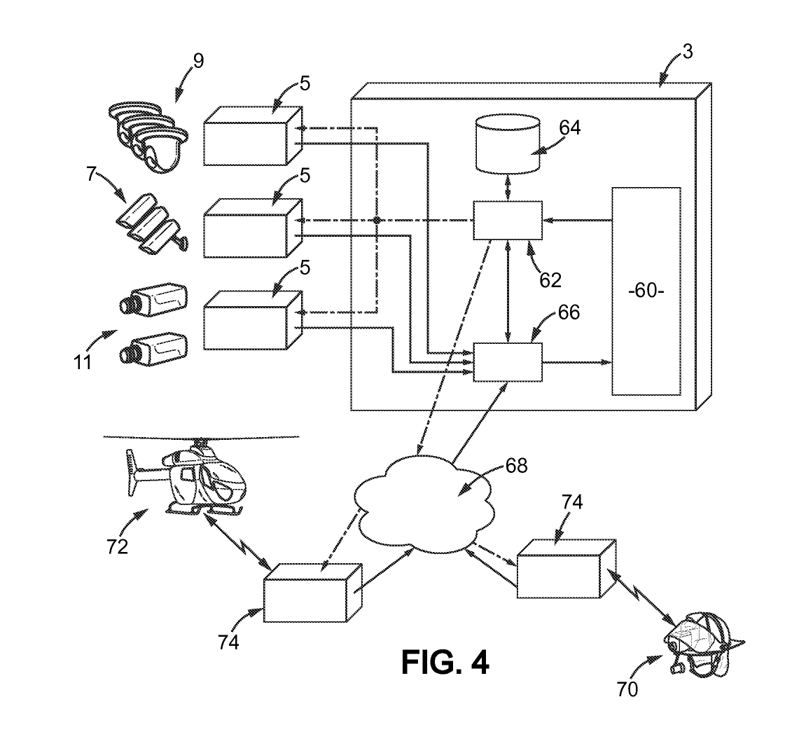

As shown in FIG. 4, the central aggregation means 3 comprise a central control station 60 having display and control means for enabling the operators of the system to act.

Orders from the operators are transmitted to the intermediate aggregation means 5 by control means 62 that are connected to a database 64 containing data about all of the video cameras in the system.

The alarms and analyzed images coming from the intermediate aggregation means 5 are combined by the merging means 66 prior to being presented to the operators.

The central aggregation means 3 also include connections with an external data network 68 enabling information to be collected that comes via appropriate processor units 74 from other mobile cameras 70, 72.

The above-described surveillance system supports two main modes of operation for detecting alarms and for operations in response thereto: a bottom-up approach or “push” mode; and a top-down approach or “pull” mode.

The bottom-up mode is used to minimize the quantity of information that goes up from the cameras to the central security station. In particular, given the very large number of images produced by the numerous cameras, it is not possible for all of the images to be sent to the central security station. Indeed, there is no need for all of them to go up to the operators, insofar as they are not capable of analyzing too great a number of video images. Only a subset of selected video images is sent to the central security station.

The information that is transmitted to the central security station is made up initially of alarms that enable the operators to focus their attention on an event.

The alarms that can be generated by image analysis are, for example, state information, change information, or crowd information.

In this mode of operation, the control means 62 instruct the lower levels to operate in a surveillance and alarm mode.

The top-down approach is used to enable an operator to focus on a specific area, on an object to the tracked, or on changes. The operator then selects the operations to be performed and the areas of interest. The control means 62 at central level select the cameras in question, and send operating instructions to them. The results of these operations are collected by the various image analysis means and they are merged in order to provide the operator with an overall view corresponding to the operator's requirements.

The invention is described and shown in detail in the drawings and in the above description. These should be considered as being illustrative and given by way of example, and not as limiting the invention to this description only. Numerous variant embodiments are possible.

For example, intermediate aggregation means may be held in reserve and may be configured dynamically as a function of requirements.

Furthermore, a sensor or local aggregation means may be connected to a plurality of intermediate aggregation means.

Likewise, the intermediate aggregation level may be structured to group together a plurality of types that are geographical or functional.

1. A surveillance system comprising:
a plurality of video detectors, and
central aggregation means comprising:
first control means for controlling the video detectors, and
display means and image analysis means for displaying and analyzing images coming from one or more video detectors,
intermediate aggregation means connected to a subset of the video detectors and to the central aggregation means, and
merging means adapted to analyze the images from at least two video detectors of the subset of video detectors in order to trigger an alarm sent to the central aggregation means as a function of the result of said analysis.

2. A system according to claim 1, wherein the intermediate aggregation means further include second control means for controlling the video detectors of the subset of video detectors and adapted to broadcast commands received from the first control means of the central aggregation means towards the video detectors.

3. A system according to claim 1, wherein the intermediate aggregation means are adapted to send images to the central aggregation means only on the request of said central aggregation means, or in association with said alarm.

4. A system according to claim 1, further including local aggregation means associated with one of the video detectors and including image analysis means for analyzing images from said video detector, and control means for controlling said video detector.

5. A system according to claim 4, wherein the local aggregation means also include interface means interfacing with at least one non-video sensor and they are adapted to transmit images from said video detector to the intermediate aggregation means in response to an event being detected by at least one of said non-video sensors.

6. A system according to claim 5, wherein the image analysis means of the local aggregation means are adapted to send an alarm to the intermediate aggregation means.

7. A system according to claim 6, wherein the alarm is forwarded to the central aggregation means by the intermediate aggregation means.

8. A system according to claim 7, wherein local aggregation means are connected to at least two intermediate aggregation means.

9. A system according to claim 1, wherein some intermediate aggregation means are put in reserve to enable the hierarchy of links between the local aggregation means, the intermediate aggregation means, and the central aggregation means to be configured dynamically.
